(19) United States
(12) Patent Application Publication
(10) Pub. No.: US 2006/0248782 A1
(43) Pub. Date: Nov. 9, 2006

(54) Mosquito breeding trap and method for eliminating mosquitoes

(75) Inventor: Blair Dancy, Austin, TX (US)

Correspondence Address: HEINZ GRETHER PC, 5810 TRADE CENTER DR., SUITE 300, AUSTIN, TX, 78744, US

(73) Assignee: Mosquito Swallow LLC

(21) Appl. No.: 11/429,683

(22) Filed: May 8, 2006

Related U.S. Application Data
(60) Provisional application No. 60/679,144, filed on May 9, 2005.

(51) Int. Cl. A01M 1/10; A01M 1/02

(52) U.S. Cl. 43/107; 43/132.1

(57) ABSTRACT

An apparatus is disclosed for mosquitoes and other “biting” insects to lay eggs which become trapped before maturing into adults. The trap comprises a reservoir filled with water and divided into two chambers 24 & 26. One chamber 24 is open to the outside at the surface to allow an accessible breeding area. The other chamber 26 is enclosed. Immature mosquitoes fall or are flushed from the open chamber 24 to the enclosed chamber 26, guided along the way by the sloping bottoms of the chambers 20 & 14. A screen, small holes, or similarly restricted exit 40 between the enclosed chamber 26 and the outside chamber 24 allows excess water to escape while retaining most or all of the trapped mosquitoes.

### REFERENCE TO RELATED APPLICATION

This application claims priority to provisional patent application serial No. 60/679,144 filed on 9 May 2005.

### FIELD OF THE INVENTION

This device and method relate to insect traps, and more specifically to traps for the offspring of egg-laying mosquitoes and other “biting” insects.

### BACKGROUND OF THE INVENTION

Mosquitoes are known vectors of dangerous diseases including malaria and West Nile virus. Controlling populations of mosquitoes is of increasing concern to the health and safety of people.

Distribution of the non-indigenous Asian Tiger Mosquito (Aedes albopictus) is rife through the southeastern United States, where it first appeared in the mid 1980s in Houston, Tex., and has now spread as far north as Minnesota and Pennsylvania. It has been named one of the one hundred worst invasive alien species in the world and is a known vector of human-infecting viruses including St. Louis, LaCrosse, and eastern equine encephalitis, Cache Valley, and dengue fever, posing a public health threat. The Asian Tiger has also become a significant nuisance mosquito. The nuisance value of the Asian Tiger may be due in part to its high aggressiveness and tendency to eat during the day rather than at night. The Asian Tiger also cross-mates with other mosquito species, but cannot cross-breed, resulting in the displacement of less aggressive native mosquito species such as Aedes aegypti.

The Asian Tiger has been labeled a “floodwater” or “tree hole” species, meaning it lays its eggs in places that are subject to later flooding, such as tree holes. Asian Tigers have also been called “container breeders” due to their preference to breed in water collected in small containers or spaces, such as used tires, old tin cans, and potted-plant saucers. The Asian Tiger is not known to lay eggs in ditches or marshes. Submersion in water due to rising water levels from rainfall causes the eggs to hatch.

Other mosquito species are known as “standing water” species, as they lay their eggs in “rafts” on the water surface.

The Asian Tiger is attracted to dark colors.

The Asian Tiger lays eggs, which turn into larvae and then pupae. At the larval stage, they are known as “wrigglers” due to their wriggling swimming motion. The larvae cling to the surface of the water, and when the surface tension is broken (typically due to rainfall), the larvae fall. After they stop their fall, they swim back to the surface. Pupae are sometimes referred to as “tumblers” and act similarly. The inventor has observed that when the swim back to the surface, they tend to swim straight up, that is, perpendicular to gravity.

Over winter, the Asian Tiger survives in the egg stage. The Asian Tiger usually stays within a half mile of its breeding site.

Other mosquitoes and “biting” insects may share the breeding characteristics of the Asian Tiger, such as Ochlerotatus japonicus, a non-indigenous tree-hole breeder recently discovered in much of the northeastern part of the United States and an “aggressive biter”, and Aedes sierrensis, a tree-hole breeder common throughout California and parts of Oregon, Washington, British Columbia, Idaho, and Utah and a carrier of dog heartworm. Aedes sierrensis adults stay within 100 feet of their breeding sites.

Current methods for eliminating or controlling mosquito populations rely heavily upon chemicals and artificial light. Some devices disseminate CO₂ (carbon dioxide) or mosquito pheromones to attract adult mosquitoes for the purpose of trapping and/or killing them. Other devices depend upon introducing bacteria or suffocating oil to breeding areas to kill mosquitoes before they become adults. Other methods include chemicals intended to ward off adult mosquitoes and fans to trap or direct them into a trap.

Methods for controlling populations also include eliminating breeding areas (i.e., eliminating sources of standing water such as old tires, pots, bird baths, roof gutters, and aluminum cans, and filling in tree holes); removing mosquito eggs, larvae, and pupae from breeding areas before they can mature into adults; and killing mosquito eggs, larvae, and pupae before they mature. These methods depend on being able to locate the breeding sites, which can be problematic. Tree holes can be hard to detect and too high to access. Small puddles can be hidden in shrubbery or in gutters. This device may provide a more attractive breeding site for mosquitoes, thereby trapping their offspring and keeping the mosquito population down.

The device described in U.S. Pat. No. 3,997,999 is designed to attract mosquitoes to breed. Once the eggs hatched, the mosquito larvae would be attracted by food in the water to swim through a screen. The screen was sized so that the larvae could not return after growing to a certain size, being thereby trapped. That device depends on an attractant (food) to lure the mosquito larvae further into the trap and does not allow for mosquitoes to be trapped based upon their natural predilection to fall and swim straight upward, nor upon the introduction of additional water to the device.

The device described in U.S. Pat. No. 6,708,443 is also designed to attract mosquitoes to breed. During the mosquito development stages, that device relies upon powered mechanisms for removing mosquitoes from water completely, and screens to filter or flush developing mosquitoes out of the infested water and into a moisture-free environment, thereby killing the mosquitoes during the development cycle. That device does not allow mosquitoes to become adults and requires the absence of water.

The devices described in U.S. Pat. Nos. 5,983,557, 6,185,861, and 6,389,740 were also designed to attract mosquitoes to breed. After the egg-laying mosquito enters that device, the mosquito is poisoned upon contact with egg-laying media. That device focuses on the egg-laying mother, not the offspring, and requires the use of poison.

During dry or cold seasons, instead of breeding or dying, some species of mosquitoes hibernate as adults. They wait for the warm wet season to return so they can resume breeding. This device may allow mosquitoes a place to continue breeding during the dry season, thereby attracting breeders who might otherwise find a safe place to lay eggs during a wet season, and trapping their offspring in the device during the dry season. This device may aid in the long-term management of mosquitoes in a given area that is subject to a dry season.

A mosquito trap that does not require chemicals, lights, CO2, pheromones, bacteria, oil, food, bait, poison, fans, automation, nor any power source would be advantageous.

### SUMMARY OF THE INVENTION

The present invention is directed to a mosquito trap specifically for trapping and killing mosquitoes and similar behaving insects by use of a base with a reservoir divided into two chambers connected by a small opening between the two, sloping floors to the chambers, dark colors, screen or mesh openings, and optional protective covers either separate from or attached to the base.

This device provides a breeding vessel for certain species of mosquitoes or similar species to lay eggs, with an enclosed chamber for trapping the mosquitoes before they mature. The breeding or open chamber provides a small stagnant pool of water. The base and any top attachment are glossy and dark or black to attract specific species of mosquito or similar insect. The eggs are deposited in the pool or on the edge of the pool.

After hatching, the larvae and pupae breathe at the surface of the water in the open chamber. An external force may break the surface tension of the water, causing the eggs, larvae, and/or pupae to fall, or they may fall on their own accord. As they fall, a sloped false bottom of the device guides the falling mosquitoes through a narrow opening on one side and into the enclosed chamber of the device. Upon passing through this opening, the true bottom of the device slopes in the opposite direction of the false bottom, that is, it slopes away from the opening. The falling mosquitoes in the enclosed chamber are guided away from this opening between the open and enclosed chambers. When the mosquitoes swim back to the surface, they swim straight up inside the enclosed chamber and do not swim to the side where the gap to the open chamber is located. Once inside the enclosed chamber, mosquitoes mature into adults. Once adults, they leave the water but cannot fly out of the enclosed chamber and are trapped and die.

The trap can be in any number of configurations. Preferred embodiments allow the device to be placed on the bottom side of a tree branch, or for placement with a protective cover, standing on its own or attached to a tree or structure. By hanging below tree limbs or similar structures or on the side of a tree or structure, the device mimics tree holes, a favored breeding site for some mosquitoes, and attracts mosquitoes for breeding.

The enclosed chamber has a small screen to the outside, allowing excess water to leave the device without allowing mosquitoes to exit and allowing some light to reach the water surface in the enclosed chamber. The screen also allows a means to “flush” the device, by providing an exit for extra water in the enclosed chamber when new water is introduced to the open chamber. The screen is located on the back or sides of the device so as to keep water from entering the enclosed chamber through the screen (which could cause a “reverse flush” and potentially introduce mosquitoes back into the open).

The natural movements of mosquito larvae and pupae may cause them to fall in the device. External forces may also break the surface tension of the water, thereby causing the egg, larva, and/or pupa to fall.

One such external force is rain. If hung from the underside of a tree limb or similar natural or artificial structure, the device collects rain water run off in the open chamber, which breaks the surface tension of the water. The optional protective cover, which can be connected to the base or a separate device, is also designed to direct rain into the open chamber while still protecting the open chamber from collecting falling debris which could clog the opening between the two chambers.

Artificial external forces used to break the surface tension may include but is not limited to water from garden hoses, watering cans, and sprinkler systems. The device's breeding or open chamber is open to the outside, allowing for spray from artificial sources to be easily guided and applied. The device is also designed to be fastened firmly to a supporting structure, be it tree, tree limb, building, or other structure, which minimizes spills of the mosquito-infested water in the enclosed chamber, or to be set onto or into the ground, using pipe or any other apparatus that would reasonably secure the device. The enclosed chambers' screen allows for more water to be introduced into the device than may be offset by evaporation, while still keeping the mosquitoes trapped in the enclosed chamber.

Other potential external forces may include any force that shakes or disturbs the water sufficiently to cause the mosquitoes to fall, such as the opening and closing of a gate when the device is attached to one of the gate's posts, or a structure that vibrates on occasion, such as the side of a garden shed or a fence near an air-conditioning unit. Users can also opt to employ mechanisms with the specific purpose of disturbing the water surface.

Once inside the enclosed chamber, the mosquitoes are trapped. If they fall within the enclosed chamber, the floor's slope away from the gap between the two chambers keeps the mosquitoes from reemerging through the open chamber. When they swim to the surface, they tend to swim directly up, minimizing the chance that they will escape. The introduction of water from the open chamber should not cause the mosquitoes already in the enclosed chamber to flush out, as the screen will filter them out of the exiting water. Once adults, they will fly out of the water in the enclosed chamber, but will still be trapped by the screen on one or two sides, water below, and solid sides around the rest.

The device is intended to be placed in an area that will be attractive to egg-laying mosquitoes, that will account for the device's various features and characteristics, and that will address the particular habits of the insect being targeted. Accordingly, placements will depend on the specific characteristics of the area and the mosquito. For example, areas with more shade, brush, and foliage (which can harbor more mosquitoes and more difficult-to-detect breeding sites) may need more devices. At least one device should be placed in every area that has potential other breeding sites so as to offer an attractive alternative. An area that has been cleared of all breeding sites may require only one device. While the Asian Tiger may travel up to a half mile from a breeding site, Aedes sierrensis adults travel only 100 feet. These differences may impact how widespread the devices need to be as well as placement. As for the device's characteristics, hanging a device under a house's eaves will not allow rain to enter the device, requiring either reliable maintenance or placement elsewhere. An area near a sports field may not be suitable for a device, given the potential of impact from an errant ball which could break the device and release the trapped mosquitoes. An area with toddlers or thirsty animals may not be suitable for a device low enough to be reached. Hanging a device over a walkway or other area where people are may also be inappropriate for safety reasons. Local foliage may also affect placement to avoid potential clogging of the device by leaves or other debris that may get past the device's cover, considering the frequency and thoroughness of maintenance of the device.

It is expected that the user of this device will introduce it into an area and, after eliminating known breeding sites and introducing the device, be able to identify remaining breeding sites that require remediation and other breeding sites that are irremediable, requiring additional devices. This process will consist of observing the source of mosquitoes after allowing the device adequate time to disrupt the reproductive cycles of the local population.

The method presented is to eliminate or limit breeding sites in an area and introduce devices such as this invention—that is, which attract egg-laying mosquitoes and similar insects and then trap and/or kill them and/or their offspring—which will then provide a means of eliminating the population over a period of time, especially during dry seasons or when all other breeding sites are successfully eliminated. The egg-laying insects will be more likely to use the trap as a breeding site rather than look for a different breeding site, thereby killing off more of the population than by merely eliminating or limiting breeding sites in an area.

It is therefore an object of the invention to provide a mosquito trap limited to attracting egg-laying mosquitoes and similarly behaving insects and trapping their offspring.

It is another object of the invention to provide a mosquito trap limited to trapping the offspring of egg-laying mosquitoes and similarly behaving insects by attracting such insects to lay eggs on or near the surface of water in the open chamber and trapping these offspring in a separate chamber that allows them to mature to the adult stage without escaping the device.

It is still yet another object of the invention to provide a mosquito trap limited to trapping the offspring of egg-laying mosquitoes and similarly behaving insects by attracting mosquitoes and similarly behaving insects to lay eggs on or near the surface of water in the open chamber and allowing or causing these offspring to fall or be flushed into the enclosed chamber during the egg, larva, and/or pupa stage of their development.

It is still yet another object of the invention to provide a mosquito trap limited to trapping the offspring of egg-laying mosquitoes and similarly behaving insects by attracting mosquitoes and similarly behaving insects to lay eggs on or near the surface of water in the open chamber, allowing or causing these offspring to fall or be flushed into the enclosed chamber during the egg, larva, and/or pupa stage of their development, and allowing or causing these offspring to fall or be flushed away from the opening that leads back to the open chamber.

It is still yet another object of the invention to provide a mosquito trap limited to trapping the offspring of egg-laying mosquitoes and similarly behaving insects by attracting mosquitoes and similarly behaving insects to lay eggs on or near the surface of water in the open chamber, allowing or causing these offspring to fall or be flushed into the enclosed chamber during the egg, larva, and/or pupa stage of their development, and allowing or causing these offspring to fall or be flushed away from the opening that leads back to the open chamber, and allowing the larvae or pupae to swim upwards in the enclosed chamber without accessing the open chamber.

It is still yet another object of the invention to provide a mosquito trap limited to trapping the offspring of egg-laying mosquitoes and similarly behaving insects by attracting mosquitoes and similarly behaving insects to lay eggs on or near the surface of water in the open chamber, allowing or causing these offspring to fall or be flushed into the enclosed chamber during the egg, larva, or pupa stage of their development, allowing or causing these offspring to fall or be flushed away from the opening that leads back to the open chamber, allowing the larvae or pupae to swim upwards in the enclosed chamber without accessing the open chamber, and not allowing the mosquitoes to escape.

It is the object of this method to provide a means of eliminating or reducing the population of mosquitoes or similar “biting” insects in a given area by limiting the choice of breeding sites to sites which trap and/or kill the egg-laying mosquito or insect and its offspring, and to discourage egg-laying mosquito or insect from seeking alternative breeding sites.

These and other objects of the invention and method, as well as many of the intended advantages thereof, will become more readily apparent when reference is made to the following description taken in conjunction with the accompanying drawings.

### BRIEF DESCRIPTION OF THE DRAWINGS

FIG. 1 illustrates a side view of one embodiment of a device designed to hang from a tree limb (or “Tree-Limb Container”).

FIG. 2 illustrates a cross-sectional view of the Tree-Limb Container shown in FIG. 1, reflecting sloped false bottom 20 divider and true bottom below 14 sloped in a direction opposite that of the false bottom 20.

FIG. 3 is a front view of the Tree-Limb Container shown in FIG. 1.

FIG. 4 is a back view of the Tree-Limb Container shown in FIG. 1.

FIG. 5 is an angled perspective of the Tree-Limb Container shown in FIG. 1 without the divider panel 20 inside the device.

FIG. 6 is an angled perspective of the Tree-Limb Container shown in FIG. 1 with the divider panel 20 in place.

FIG. 7 illustrates a side view of an embodiment of the device designed to be attached flush to a fence, tree, or other vertical structure (or “Flush-Hanging Container”). FIG. 7 also reflects placement of screws or nails in tabs or holes 78 for hanging the device on a tree, fence, or structure, as well as the protective cover 72, 74, and 76 on the top half, which extends just beyond the open or breeding chamber 18 in the lower half of the device before angling back to a tip 76 just above the center of the surface of the breeding pool. FIG. 7 also illustrates a screen 70 (or small holes shown in a triangular pattern), allowing water to escape from the enclosed chamber 26.

FIG. 8 is a cross-sectional side view of the Flush-Hanging Container shown in FIG. 7, reflecting false bottom 20 with slope and true bottom 14 below with slope in the other direction. FIG. 8 reflects that the device is manufactured in two parts which fit together.

FIG. 9 is a front view of the Flush-Hanging Container with tabs 78 and holes 80 for screws or nails to secure the device to a vertical structure.

FIG. 10 is an angled perspective of the Flush-Hanging Container illustrated in FIG. 7.

FIG. 11 illustrates a side view of an embodiment of a device designed to stand alone (or “stand-alone container”). This view shows the device's protective cover 117, 118, and 119 connected to the base 110 and 114, which also directs rain-water run off into the open chamber 126, and the screens or holes 116 on the side 114 which keep the mosquitoes trapped and provide drainage.

FIG. 12 is a cross-sectional side view of the stand-alone container shown in FIG. 11, reflecting a funnel open chamber 126 directly over an inverse cone 122.

FIG. 13 is an angled perspective of the stand-alone container.

### DETAILED DESCRIPTION OF THE INVENTION

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents, which operate in a similar manner to accomplish a similar purpose. Likewise, specific dimensions should be understood as being offered by way of example and not by way of limitation.

Tree-Limb Container:

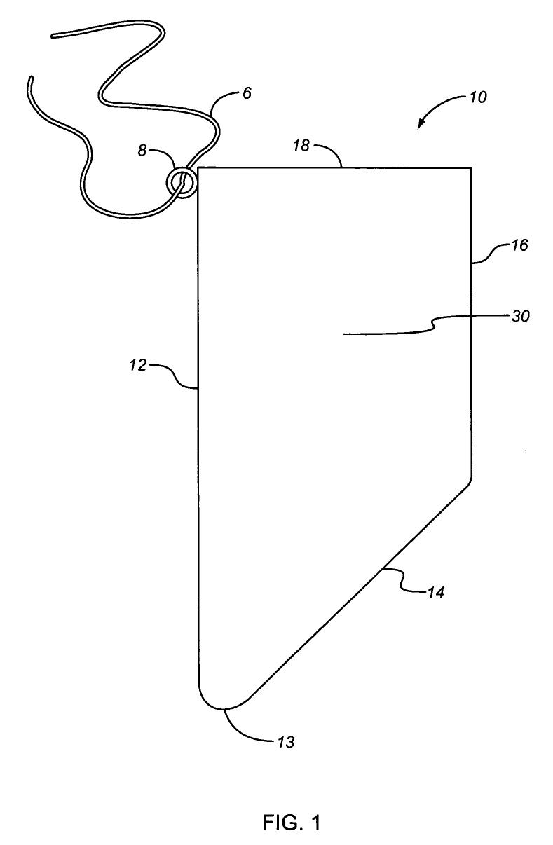

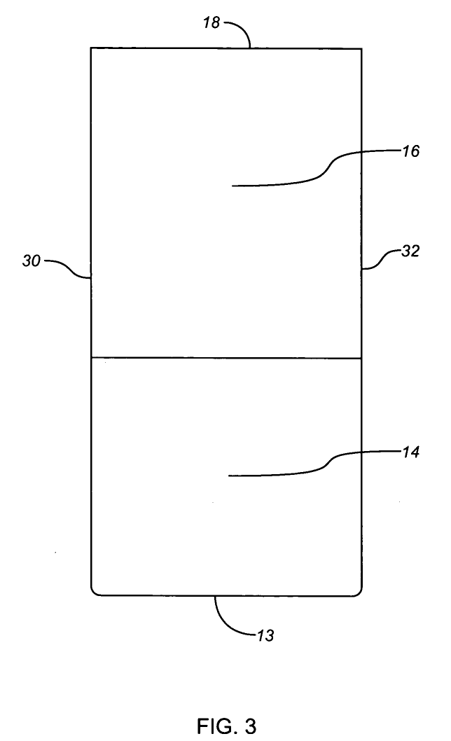

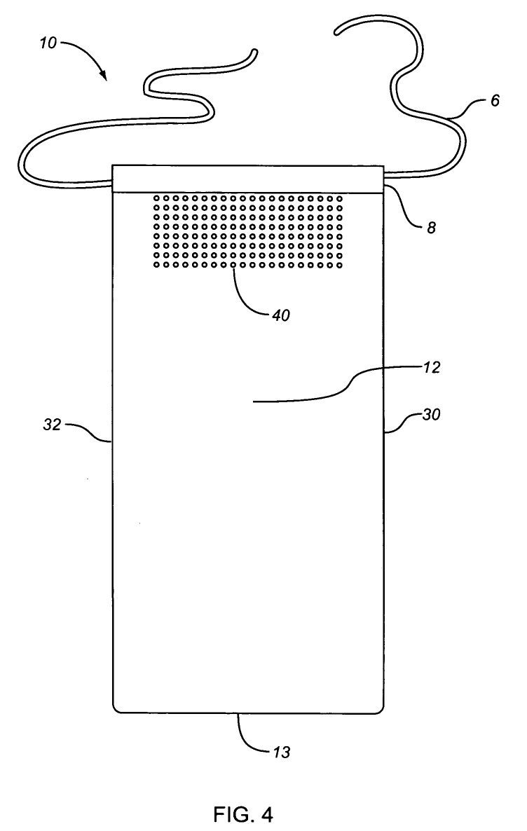

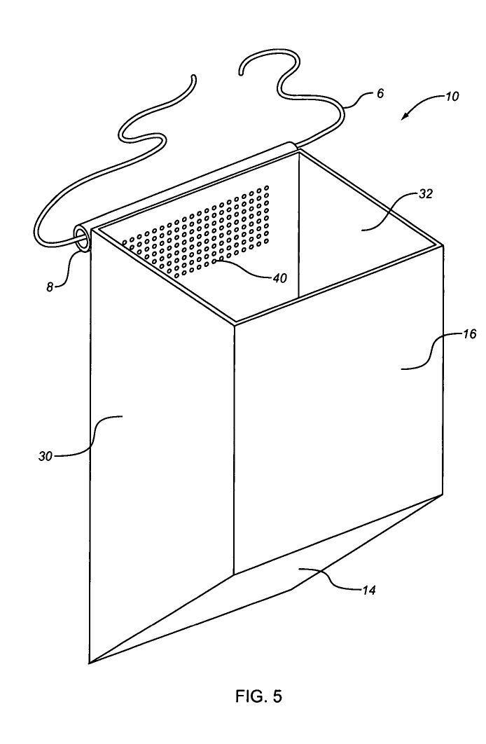

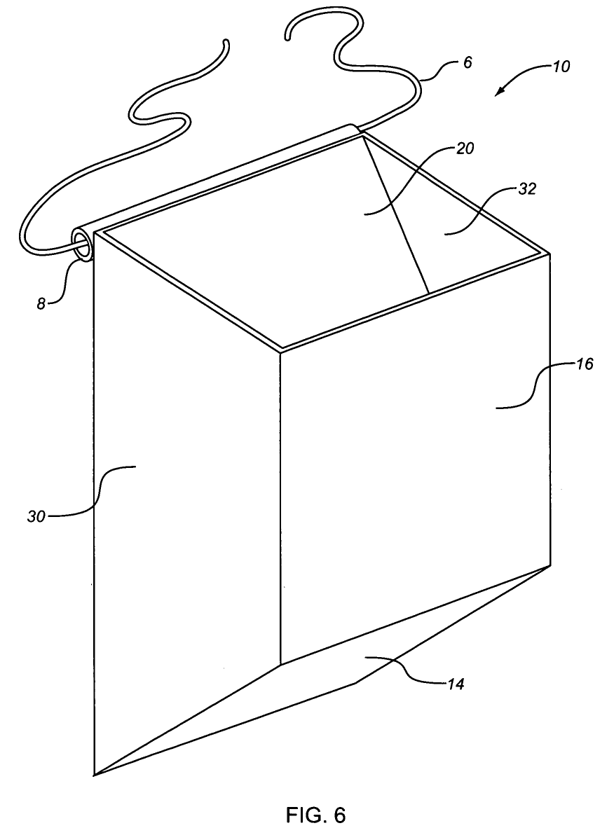

FIG. 1 through FIG. 6 illustrate and embodiment of a Tree-Limb Container 10. The one illustrated is approximately 8″ tall Preferably, the device is glossy black or some similar dark color. Suitable materials include but are not limited to: plastic, ceramic, aluminum or stainless steel. It is only necessary that the material be relatively sturdy enough to maintain the functional geometry of the device as further described herein. In the preferred embodiment the device includes a fine mesh screen (or multiple holes grouped together) 40 as seen in FIG. 4 and FIG. 5. The size of the holes are designed to prevent the escape of the mosquito in any stage of its lifecycle. The applicants have found that one sixteenth ( 1/16^{th}) of an inch to be suitable for the target mosquito of the embodiment shown. The device also includes fastening points 8 for screws, pipe, or other attachment accommodations such as the cord 6 illustrated in FIG. 1. From a top viewpoint as seen in FIG. 6 the four sides 12, 16, 30, and 32 create a square roughly four inches (4″) on each side.

The back side 12 as seen in FIG. 4 is roughly four inches (4″) wide, flat, and zero degrees to vertical (non-sloping), and approximately eight inches (8″) tall. As seen in FIG. 4 the back side 12 is approximately three inches (3″) wide, and one inch (1″) tall rectangular window of fine screen or grouping of holes 40, with mesh or holes approximately one-sixteenth ( 1/16^{th}) of an inch wide. Variations may provide for finer mesh or holes on the lower part of the screen.

The bottom side 13 is approximately one inch by four inches (1″×4″) and is shown as curved in FIG. 1. In an alternative embodiment this panel 13 may be flat and connected at a right angle to the bottom of the back side 12, running its length and extending towards the front side, sloped bottom 14.

The front side slopped bottom 14 and front side 16 is solid, flat, and four inches (4″) wide for its entire length. Its sloped bottom side 14 is flush with one side of the bottom panel 13, and slopes up at an angle to the to front side 16. at roughly half the height of the back side 12 is four inches (4″). Then the front side 16 continues upwards at zero degrees to vertical for approximately four inches (4″).

Both left and right sides 30 and 32 are solid, flat, and zero degrees to vertical (non-sloping). The top half of both left and right panels 30 and 32 are approximately four inches (4″) wide at their widest. The bottom half of both left and right panels 30 and 32 are shaped to fit the back 12, bottom 13, sloped bottom 14, and front 16 sides to form a water-tight container.

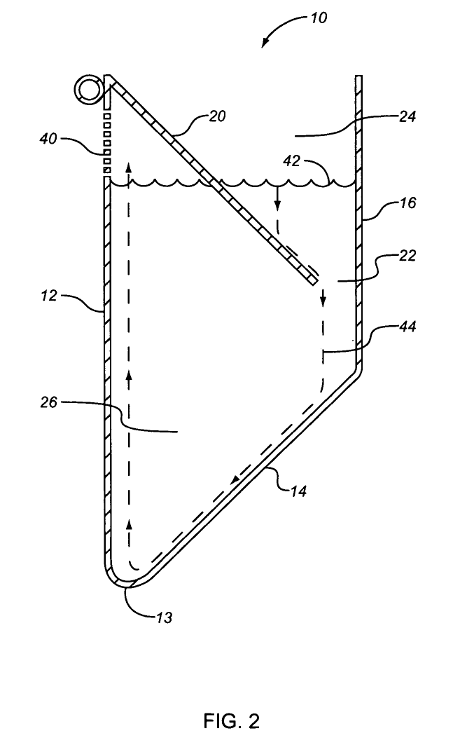

FIG. 2 and FIG. 6 illustrate a sloped rectangular divider panel 20 inside the device, approximately four inches (4″) wide and approximately five and one third inches (5.33″) in length. It is solid, flat, and sloped. It is connected or flush along the entire four inches (4″) of the top edge of the back side 12 and to the insides of both the left and right panels 30 and 32. It is sloped down toward the front side 16, but short of intersecting the front side panel, leaving a gap 22 of approximately one half an inch (0.5″) between the bottom of this panel 20 and the front panel 16 leaving a passage from the open chamber 24 into the enclosed chamber 26.

In use the device is filled with water or other liquid to level line 42 thus providing an attractive breeding and/or development medium for mosquitoes and similar species. The mosquitoes will be attracted to the glossy black or dark coloring of the chamber and the small, stagnant body of water. If properly placed, the device will provide a more desirable breeding site than other naturally and artificially occurring sites, that is, small containers or spaces that collect water, such as used tires, old tin cans, potted-plant saucers, and tree holes.

After laying eggs, the mosquito may leave behind pheromones that will help attract other egg-laying females.

Proper placement from a tree limb may also keep animals from drinking from and spilling the mosquito-infested water.

The path 44 of the mosquito eggs can best be seen in FIG. 2 The mosquito eggs will hatch into larvae and then develop into pupae. During these development stages, the mosquitoes will fall or be forced (flushed) from the open chamber 24 into the enclosed chamber 26. The open and enclosed chambers 24 and 26 are separated by a divider or “false bottom” 20 which is the sloping barrier that forms the bottom of the open chamber. The false bottom 20 ends with a gap 22 which allows a passage for the mosquitoes to enter the enclosed chamber 26. The slope of the false bottom 20 directs the falling or flushed mosquitoes towards this gap 22.

The slope on the bottom 14 of the device after this gap 22 is in the opposite direction. After passing the gap 22 and entering the enclosed chamber 26, the mosquitoes will continue to fall or be flushed downward, but away from the gap/passage 22.

The fallen or flushing mosquito larvae and/or pupae will reorient themselves and swim directly upward, to the surface inside the enclosed chamber 26. If more water is added to the device, the mosquito larvae, pupae, and adults will not be able to pass through the screen or grouping of holes 40 (or if small enough to get through the exit, will be in a stage of development that will not allow the mosquito to live out of water) but the water itself will be able to escape, thereby trapping (or killing) the mosquitoes.

The addition of water to the open chamber 24 will aid the trapping of mosquitoes during these developmental stages. The development of a mosquito from egg to adult can take an estimated 9 to 14 days. It is therefore recommended that water be added to the device once a week.

Flush-Hanging Container:

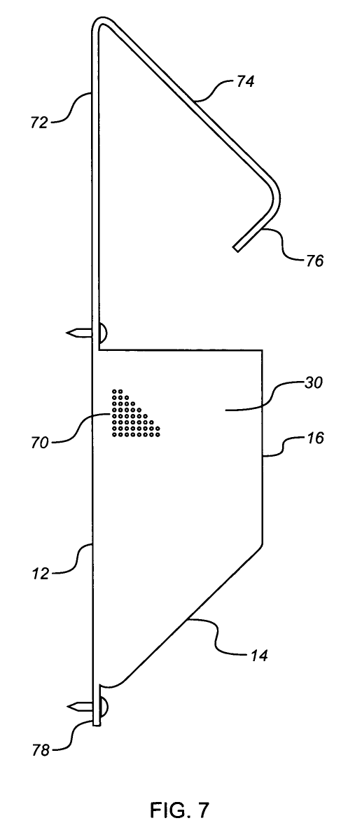

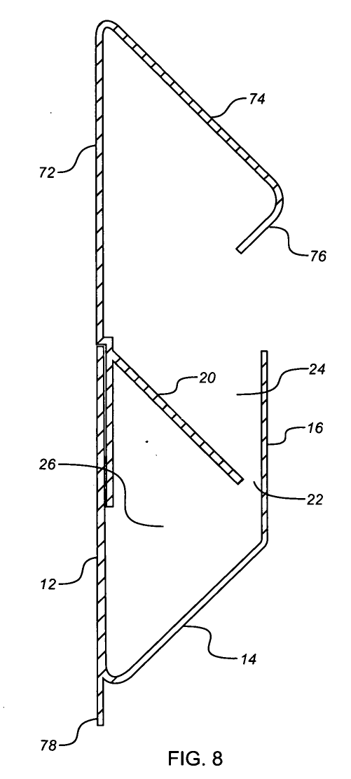

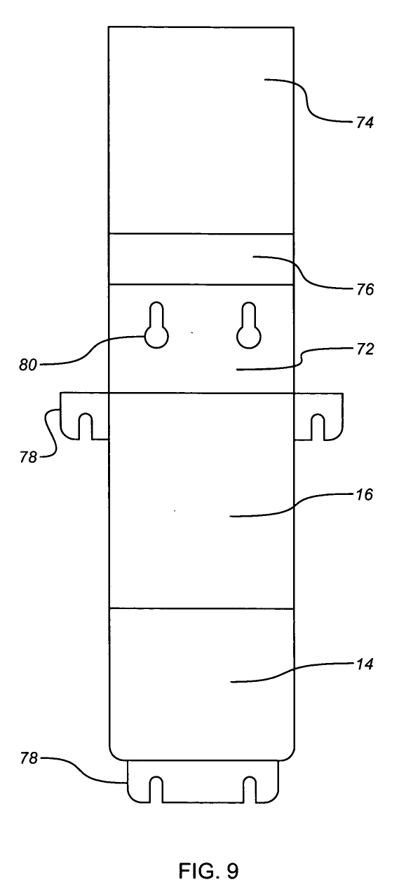

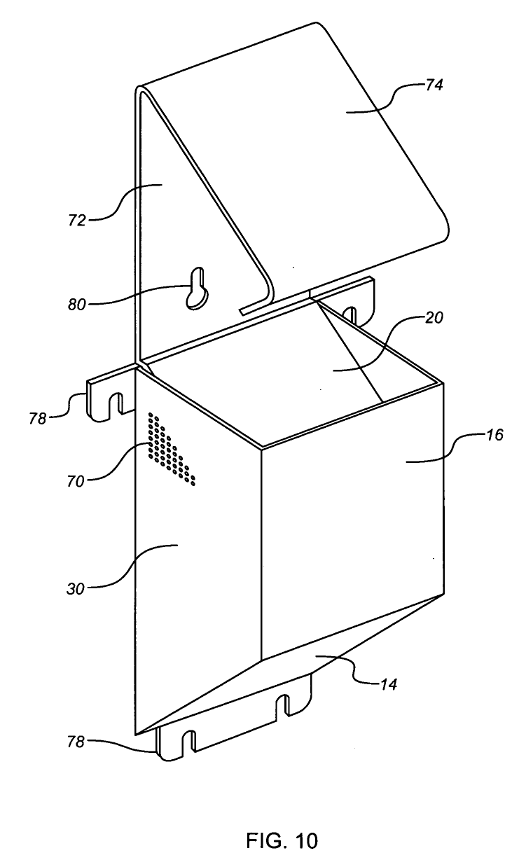

Please see FIGS. 7 through FIG. 10 which reflect a slight variation to this design from the Tree Limb Container. This device is identical to the device shown in FIG. 1 through FIG. 6 with the exception of the location of the screen or holes 70, the addition of a protective cover 72, 74, and 76, and the addition of tabs 78 and holes 80 for securing the device to a tree or structure with screws or nails. Another variation may include a hole in the bottom half for insertion of a pipe which in turn is stuck into the ground or other medium.

The screen or drainage holes 70 are located on the side 30 and/or 32 to avoid getting the tree or structure wet every time there is an excess of water exiting the device. The shape of the screen or grouping of holes 70 is triangular, with the top of the screen or holes ending at just below and running parallel to the bottom of the inner divider panel 20. The screen or grouping of holes 70 is approximately two inches (2″) high by two inches (2″) wide at the bottom.

The protective cover 72, 74, and 76 provides the same protections that a tree limb might otherwise provide, such as protection from debris entering the open chamber, protection from animals drinking from the device, and spilling the mosquito-infested water. The protective cover may also provide a darker pool of water for a more attractive breeding site which better mimics tree holes and similarly attractive breeding sites by providing shade.

The protective cover itself connects to the back of the back side 12 and covers the top of the base 18, leaving approximately two and one half inches (2.5″) between the top of the base 18 (the opening to the open chamber with the breeding pool) and the lowest point of the cover 76 that extends directly over the open chamber. The back of the cover 72 extends eight inches (8″) above the top of the base 18 in a continuation of the four inches (4″) wide back side of the back side 12. From the top of the cover forward, the cover 74 is four inches (4″) wide and extends downward and toward the front of the base at an angle of approximately forty-five degrees (45°) until it extends one-half inches (½″) horizontally beyond the front of side 16. The cover 76 then comes to a right angle and then continues downward and toward the back of the backside 12 at approximately a forty-five degree (45°) angle for approximately two inches (2″), stopping over the middle of the exposed breeding pool in the open chamber 24 when the device is filled with water. The sides of the cover are straight on the back 72 and top of the cover 74, but the part that recedes back towards the back side 76 is triangular, with a four inch (4″) base at the right angle between it and the top, and two additional sides of equal length, meeting in a corner in the midpoint of the sides of the base and cover to enable water run off to come to a point and fall in drips or a stream.

The device may be attached to a tree or structure with screws or nails in the tabs 78 and holes 80 in the back of the cover 72, or into the ground using pipe stuck into the bottom hole. It is important that the device not be subject to spilling during storms or other interference.

Stand-Alone Container:

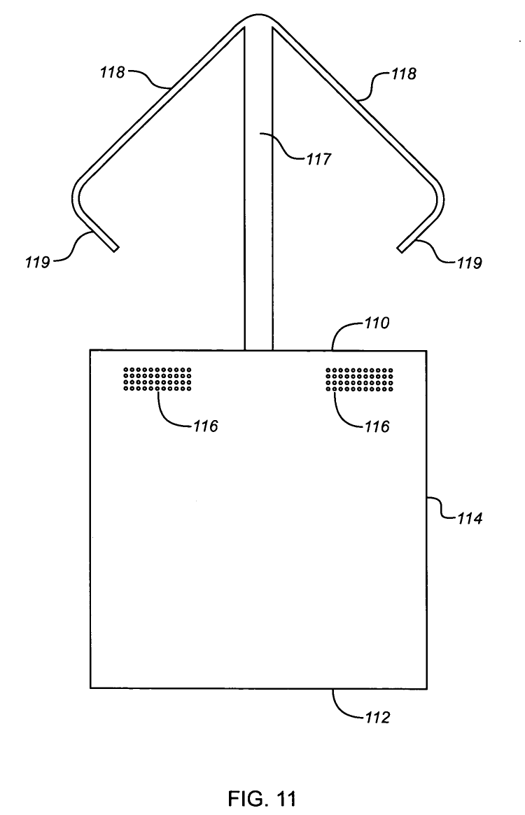

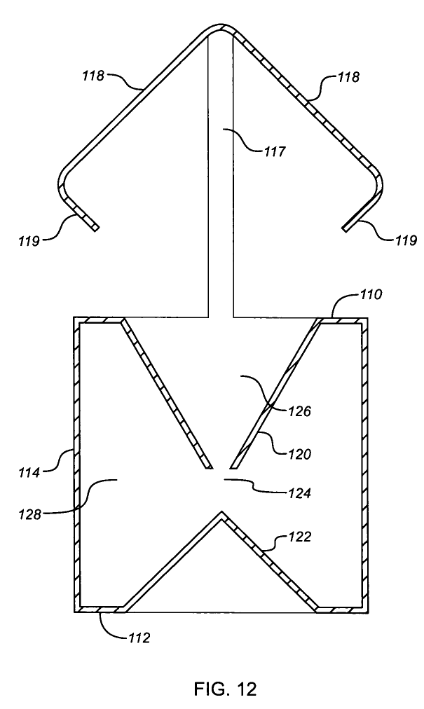

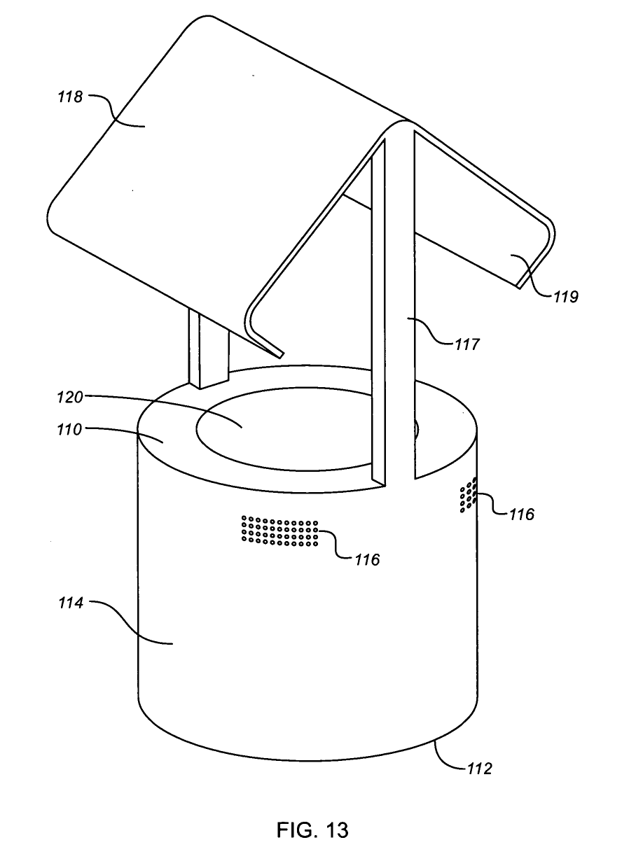

Please see FIGS. 11 through FIG. 13 which reflect a slight variation to this design from the Tree Limb and Flush-Hanging Containers. This device is a glossy black or dark cylindrical bucket made of plastic, ceramic, or other sturdy material, approximately twenty-four inches (24″) in diameter and twenty-four inches (24″) in height, designed to stand alone and resist being spilled by animals or people, mainly due to its increased size and weight in comparison to the Tree-Limb and Flush-Hanging Containers. The top of the base 110 is fitted with a funnel 120 in the middle, extending slightly less than halfway down towards the bottom 112 (about eleven inches (11″)) and beginning about four inches (4″) in from the side 114. The bottom 112 is flat only from the outside rim of the bucket to about four inches (4″) in from each and then slopes upward 122 into a cone, the tip of which extends less than halfway to the top of the base 110 (about eleven inches (11″)). One inch below the top of the side of the base 114, there are four screens or groupings of holes 116 spaced evenly around the device, which are one inch (1″) high by thee inches (3″) wide.

The gap 124 between the funnel 120 and the cone 122 provides the same separation between the open and enclosed chambers 126 and 128 as the gap 22 in the Tree-Limb and Flush-Hanging Containers between those chambers 24 and 26. The device works identically to the Tree-Limb and Flush-Hanging Containers in respect to the attracting of egg-laying mosquitoes and trapping of developing mosquitoes in the enclosed chamber 128 (chamber 26).

The protective cover 117, 118, and 119 provides the same benefits as the protective cover 72, 74, and 76 for the Flush-Hanging Container. The cover 117 may be connected to the base 110 and 114 in more than one place. The cover 118 adds another twenty four inches (24″) to the height and extends an additional one inch (1″) out to two sides, and extends back 119 towards the middle of the device until its bottom tips are over the surface of the pool in the open chamber 126.

This invention does not attract adult mosquitoes for the purpose of destroying them, but attracts them only for purposes of breeding. This invention traps the offspring of the adults that are attracted to it, thereby cutting off the breeding cycle. By allowing the mosquitoes to live and the offspring to grow to adult hood, the device limits the amount of any chemicals or other indicia in the water itself that could warn an egg-bearing mosquito not to lay eggs in the trap.

This invention allows desirable placement to lure mosquitoes away from less obvious breeding sites, thereby requiring less than total elimination of standing water in a given area.

This invention does not kill mosquitoes during the egg, larva, or pupa stages. Rather this invention traps them in those stages and allows them to fully mature. Once fully mature, the adults remain trapped and die from being deprived of food, a place to rest, drowning, or other problems associated with being trapped in a small area with a pool of water below.

This invention depends on the natural predilections of certain species of mosquito and other insects:
As adults, to breed in stagnant water, preferably in a dark place;
As eggs, larvae, and/or pupae, to sink to the bottom of the water when the surface tension is broken;
As eggs, larvae, and/or pupae, to be prone to be moved through a small body of water when a small volume of water is introduced;
As eggs, larvae and/or pupae, to sink to the bottom of water naturally; and
As larvae and/or pupae, to resurface in water by swimming straight up after falling.

The method of using this device and similar devices depends on eliminating or limiting the number of attractive breeding sites in an area. In many areas, it will be impossible or impracticable to eliminate such sites completely, leaving some breeding options for mosquitoes during rainy periods or in areas that are artificially irrigated, such as urban residential lawns. The method involves placing a device that attracts egg-laying mosquitoes and traps and/or kills such mosquitoes and/or their offspring in the area where other breeding sites have been eliminated or limited. During the dry season, mosquitoes will continue to use the trap while they will not use other breeding sites that have dried up temporarily. This method will aid the longer term control of certain species of mosquitoes and similar insects in a given area.

Other methods tend to focus on a localized area. This method can be expanded to all areas with the Asian Tiger or other localized species of insect, so as to eradicate the species entirely from larger areas. The ultimate goal of this device is the extinction of the Asian Tiger from a given area, especially given that the Asian Tiger is not indigenous to the Americas nor many other countries where it now exists.

This method also includes placing traps around ports which may experience the accidental import of non-native, invasive insects such as the Asian Tiger. Seeking easily accessible breeding sites, the invasive species may leave eggs in traps rather than seek out non-trap breeding sites that are farther away, less accessible, or otherwise less desirable.

This device and this method are intended to be inexpensive, simple, and easy to maintain for widespread use in areas with Asian Tiger or other water-birthing species of mosquito and other insects, including urban, suburban, rural, commercial, and industrial areas. If widespread enough, the invention could significantly control or eradicate the non-indigenous Asian Tiger and similar species from an area or even from the Americas all together, given the Asian Tiger's limited range of travel to a half mile from breeding sites.

While this invention was designed specifically with the Asian Tiger in mind, it applies to any species of mosquito or other insect with similar characteristics. This invention has application to any mosquito or other insect that lays its eggs in or near standing water and whose eggs, larvae, or pupae can fall below the surface water.

The foregoing descriptions should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

What is claimed is:

1. An insect trapping apparatus, comprising:
an open reservoir capable of holding water, with two chambers divided by a sloping divider leaving a gap connecting the two chambers, with the first of the two chambers open at its top, with the second of the two chamber enclosed with restricted exit to allows water to exit the enclosed chamber when the water level reaches a certain height but does not allow mosquito eggs, larvae, pupae, or adults to exit.

2. The insect trap as claimed in claim 1, wherein the reservoir is of a dark color.

3. The insect trap as claimed in claim 1, wherein a top is attached to the reservoir leaving the water exposed to the outside environment, and which is sloped to direct water landing on the top towards the center of the water reservoir.

4. The insect trap as claimed in claim 1, wherein the restricted exit has apertures no larger than ⅙^{th} of an inch in diameter or width.

5. The insect trap as claimed in claim 1, wherein the divider is sloped towards the gap connecting the two chambers, and wherein a floor or bottom of the enclosed chamber is sloped away from said gap.

6. An insect trap with two water-holding chambers the first an open chamber to attract egg-laying mosquitoes and the second an enclosed chamber to retain the offspring through the rest of their life cycles.

7. The insect trap of claim 6 where the open and closed chambers are separated by a divider that separates the two chambers and directs sinking mosquito eggs, larvae or pupae layed in the open chamber into the enclosed chamber.

8. The insect trap as claimed in claim 6, wherein the base is of a dark color.

9. The insect trap of claim 6 new water can flow into the open chamber, into the enclosed chamber.

10. The insect trap of claim 9 wherein the enclosed chamber includes an exit that allows water to exit but not mosquito eggs, pupae, larvae or adults thus preventing the chambers from over filling.

11. The insect trap as claimed in claim 6, wherein a top is attached to the open chamber leaving at least one side of the device exposed between the top and the base to the outside environment, and which directs water landing on the top into a concentrated flow towards the open chamber.

12. The insect trap as claimed in claim 10, wherein the water exit is a series of apertures with dimensions no larger than 1/16^{th} of an inch.

13. The insect trap as claimed in claim 6, wherein both chambers have floors or bottoms wherein the floor or bottom of the open chamber which is sloped towards the passage between the two chambers, and wherein the floor or bottom of the enclosed chamber is sloped away from said passage.

14. A method for trapping mosquitoes introducing breeding sites that trap the mosquito offspring.

15. The method as claimed in claim 11, wherein the breeding trap is maintained through a dry season.

16. The method as claimed in claim 11, wherein breeding traps are maintained throughout a large area for a season or longer, thereby significantly reducing the population from a given area.

17. The method as claimed in claim 11, wherein the breeding trap is maintained throughout a large area for a season or longer, and then moved to the next proximate area which the mosquitoes inhabit, thereby significantly reducing the population from one area to the next.

18. The method as claimed in claim 11, wherein breeding traps are maintained throughout an area that receives imports, thereby reducing the risk of an accidental influx of an invasive mosquito species.
